(19) United States
(12) Patent Application Publication
(10) Pub. No.: US 2004/0179357 A1
(43) Pub. Date: Sep. 16, 2004

(54) Tubular lamps for fluorescent lighting

(76) Inventor: Heiner Kappe, Lohmar-Heide (DE)

Correspondence Address: MARSHALL, GERSTEIN & BORUN, Carl E. Moore, Jr., Sears Tower, Suite 6300, 233 S. Wacker Drive, Chicago, IL, 60606-6357, US

(21) Appl. No.: 10/386,043

(22) Filed: Mar. 11, 2003

(51) Int. Cl. F21V 23/02

(52) U.S. Cl. 362/222; 362/223

(57) ABSTRACT

A light fixture for mounting small diameter fluorescent lamps (e.g., T5 lamps) into lamp holders designed for large diameter lamps. The fixture comprises at least one outer tube which is at least partially transparent, a reflector surface within the tube, and tracks for holding a circuit board. Adapters at each end of the tubular fixture contain sockets for mounting a small diameter fluorescent bulb within the fixture, and pins for mounting the light fixture into conventional lamp holders.

### SUMMARY OF THE INVENTION

In the last few years, advances in fluorescent lamp technology have led to a steady decrease in the average diameter of fluorescent lamp tubes. This results in not only a decrease in the amount of glass needed but also a reduction in the required energy to operate the lamps. At the same time, new luminous substances have been developed that provide the same or even higher lumens with smaller surfaces and less energy.

The diameter of the original, standard fluorescent lamps was set based on the American measurement of ⅛ inches; for example, a fluorescent lamp with the description T8 has a diameter of approximately 8/8=1 inch=25.4 mm. Starting with T12, large quantities of T10 and T8 lamps were produced, and today a few billion T8 lamps are being used.

Since 1998, more and more T5 lamps are being produced, and soon we can expect the overwhelming use of these new lamp types, since they provide the same amount of light and use up to 40% less energy!

Since the smaller diameter does not allow the current gap of the contact pins of approximately 13 mm, new standards were established to allow the use of T5 fluorescent lamps in previous lamp holders without major effort. One result of this standardization is that the T5 fluorescent lamps are approximately 5 cm shorter, so that with corresponding transition piece—so—called adapters—T5 fluorescent tubes can be used as lamps in current light fixtures.

Numerous patents describe such transition pieces or complete “retrofit” semi-lights that not only balance out the length differences, but also contain the necessary electronic components required for the operation of the new T5 fluorescent lamps (DE 195 12 307 A1; DE 198 54 440 A1).

The purpose of the present invention is to describe an extremely simple and cost-effective model of a T5 light, which is suitable as an independent light or as a “retrofit” semi-light for conversion of current T8 or T10 lights to the new T5 technology.

In a known manner, the carrying component should be a cylindrical tube made of transparent plastic, which, with appropriate adapters on the ends, allows the insertion of a shorter T5 fluorescent lamp into the carrying component, and which also allows use in current T8, T10, or even T12 lights with the corresponding contact pins, whereby all electronic components are also contained within the tube.

The improvement as per the invention consists in that there are light-reflecting surfaces on the inner wall of the tube that direct the light from the T5 fluorescent lamp in the desired direction. The light-reflecting surfaces can be extruded in the form of a flat surface or a curved surface in order to attain the desired focus of the light.

An additional improvement consists of providing tracks for the acceptance of an electronic module on the light reflecting surfaces or at other points where, e.g., a printed circuit board having electronic components can be inserted during the assembly of the lamps.

Additional reinforcing ribs can also contribute to the stiffening of the tube.

The extruded transparent tube can also be provided with a light-scattering groove profile in the area of the light reflection. In the area of the tube, in which no light reflection occurs, it is recommended—if desired—that an opaque layer be applied to cover the inner surface of the tube.

The optimal model of a light as per the invention is, without a doubt, an extruded tube made of two different plastics, namely a transparent or translucent material in the light-reflecting area and an opaque material in the other area. The entire light can be created in one single fully automated work cycle; and, based on another solution as per the invention, the adapters can be attached to the ends without additional effort.

Another version of the invention consists of arranging two tubes within each other: a white opaque tube within an outer transparent tube, whereby the inner tube only encompasses approximately half the area. For this embodiment, the tool effort is less complex and it is possible to structure the outer tube in a different manner, e.g., smooth, rippled or in different colors.

With correct dimensioning of the diameter of the tube, e.g., in close accordance with the dimensions of T12 or T10 fluorescent lamps, even conventional, waterproof lights can be converted.

Another version of the invention consists of constructing the inner profile as a flat extruded piece made of white plastic with ribs in the outer tube to position the inner profile. With a symmetrical arrangement of the flat inner profile, it is provided in another embodiment of the invention that the symmetrical halves of the outer tube be structured differently: for example, one half with a groove pattern and the other half as ungrooved and totally transparent. The user then has two options, grooved and ungrooved, and can use the light as desired by turning the inner profile by 180° and inserting it into the outer tube.

In order to avoid additional work on the extruded profile, as per the invention, it is recommended that the inner profile be somewhat shorter than the outer tube in order to maintain a small gap between the inner profile and the end plates of the adapter so that electrical connection lines can be led, for example, from the electrical components to the contact pins of the adapters.

In order to define the small gap between the inner profile and the end plates of the adapter, we suggest adapter supports near the connector screws, e.g., like eyes around the screw holes.

It is cheaper if the ends of the inner profile are designed as per the invention so that they have enough space to be able to use a self-boring screw. Moreover, connection lines pre-fitted with plug-ins can be fed between the two adapters in the forked slits.

### BRIEF DESCRIPTION OF THE DRAWINGS

The following is a detailed description of the invention, from which additional invention characteristics can also be taken.

FIG. 1 shows a simple diagram of a tube as per the invention.

FIG. 2 depicts a tube made of two different types of plastics.

FIG. 3 is a longitudinal section of the end of a light as per the invention.

FIG. 4 is a schematic view of the printed circuit board with wiring.

FIG. 5 is an example of a clamp attachment of the adapter in the tube.

FIG. 6 is a cross-section through the adapter.

FIG. 7 shows an inner half tube in cross-section.

FIG. 8 shows an assembly in cross-section.

FIG. 9 and FIG. 10 show the two versions with an outer tube (1) shifted by 180°.

The figures are to be interpreted as schematic examples, any of the details of which can be varied without changing the protective circumference of the patent claims.

### DETAILED DESCRIPTION OF THE PREFERRED EMBODIMENT

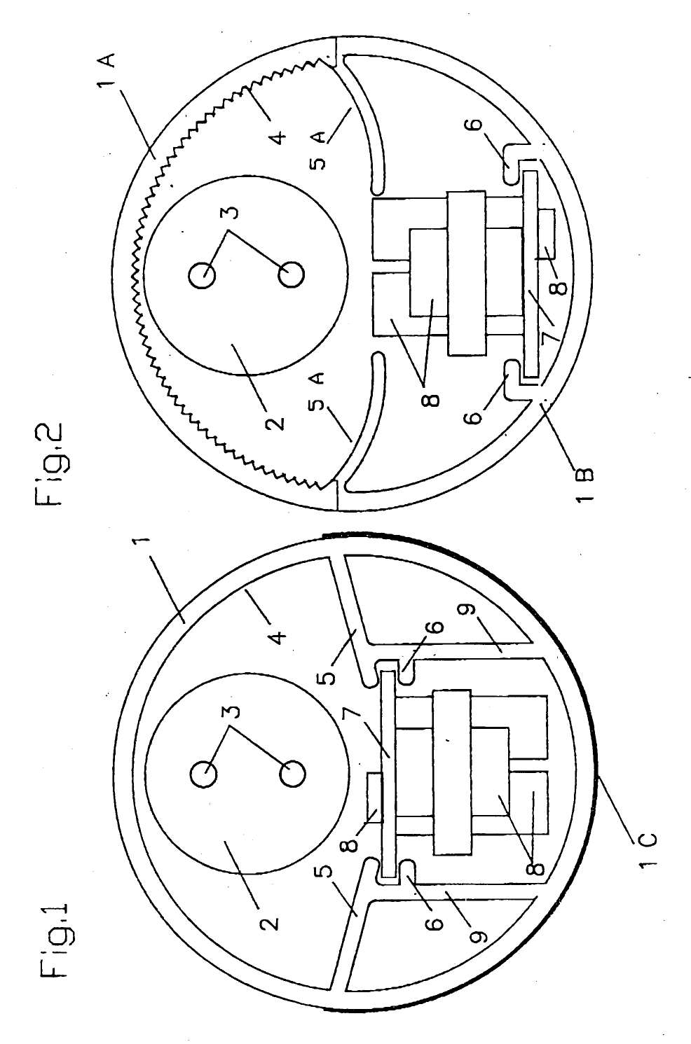

FIG. 1 shows the cross-section of a simple smooth tube (1) made of plastic, in which a T4 fluorescent tube (2) with contact pins (3) is arranged in an off-center manner. Light-reflecting surfaces (5) are arranged on the inner wall of the tube (1) and are supported with reinforcements (9) in order to increase the stability of the tube (1). The reflecting surfaces (5) can be extruded in one working cycle with the tube (1). Additionally, there are shoulders (6) defining a track in which a printed circuit board (7) with the electronic components (8) necessary for the operation of T5fluorescent tubes (2) can be inserted. As shown in FIG. 1, shoulders (6) are formed integrally with reflecting surfaces (5).

A tube coating (1C) can be applied to the non-light-reflecting side in order to cover the parts located on the inside of the tube (1). Since, with many of today's products, like watches, the innards are often visible, a coating may not necessary, which can mean considerable cost savings.

The arrangement of the light-reflecting conducting surfaces (5) is particularly important since it increases the light reflection by up to 80%, which is otherwise rather difficult to attain.

FIG. 2 shows an example with further improvements. The extruded tube (1) is made, in this case, of a translucent material in area (1A) and a non-translucent plastic in area (1B), preferably of a white material. This type of combination is preferably manufactured in one single extrusion process. In area (1A), the coordination for a light-scattering groove profile (4) is also shown. In FIG. 2 curved conducting surfaces (5A) are also shown as examples.

The shoulders (6) for holding the printed circuit board (7) are displayed directly on the inner wall of the tube (1) as simple hook profiles which can decrease the tool costs.

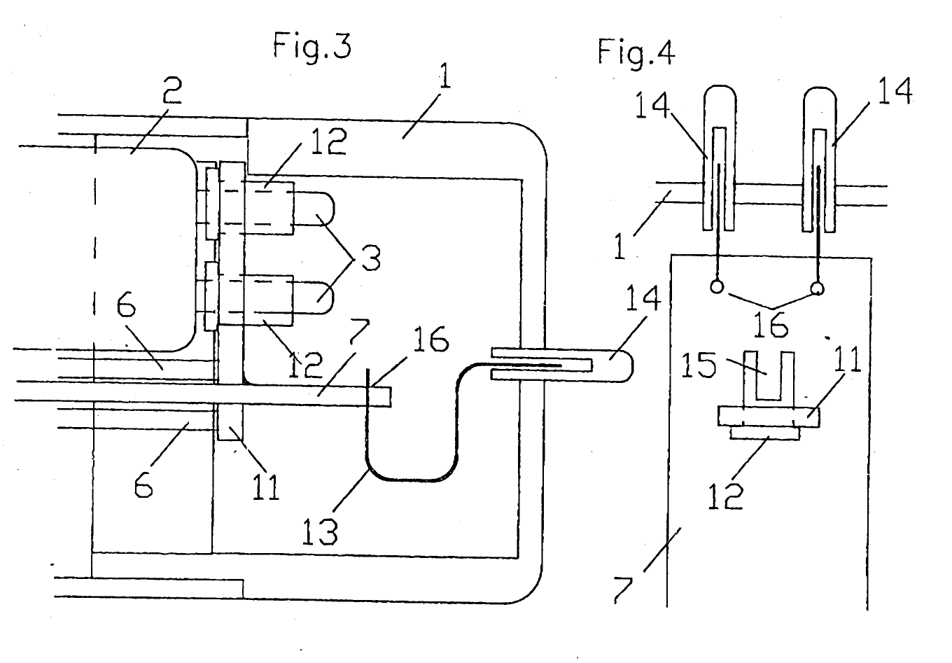

The longitudinal view in FIG. 3 shows further details of the invention, especially the switching of the printed circuit board (7) which contains the electronic components (8) with the contact pins (3) for the T5 fluorescent lamps (2) with a second printed circuit board (11) that is mounted on the printed circuit board (7) to save any extra cabling. Spring tension contact sockets (12) with slits (15) in them are mounted in the printed circuit board (7) for the contact pins (3) to be inserted into. As shown in FIG. 4, solder connections (16) are also provided on the printed circuit board (7) so that connection wires (13) can be connected to the contact pins (14). The contact pins (14) correspond in their allocation, positioning and dimensions to the standards of the previous T8- or T10 fluorescent lamps so that the “retrofit” lamps based on the invention can replace the existing “old” lamps without any misgivings.

To exchange a burned out T5 fluorescent lamp (2), the adapter (10) must be able to be removed from the tube (1) with a tool. The construction based on the inventions provides at least one and better two clamp sockets (20) on the adapters (10) which run on a suitable plane (18) on the long axis (17) and is clamped under pressure by the clamping screw against the inner wall of the tube (1). The clamp sockets slide into angled guides (21) which are included in the adapters (10).

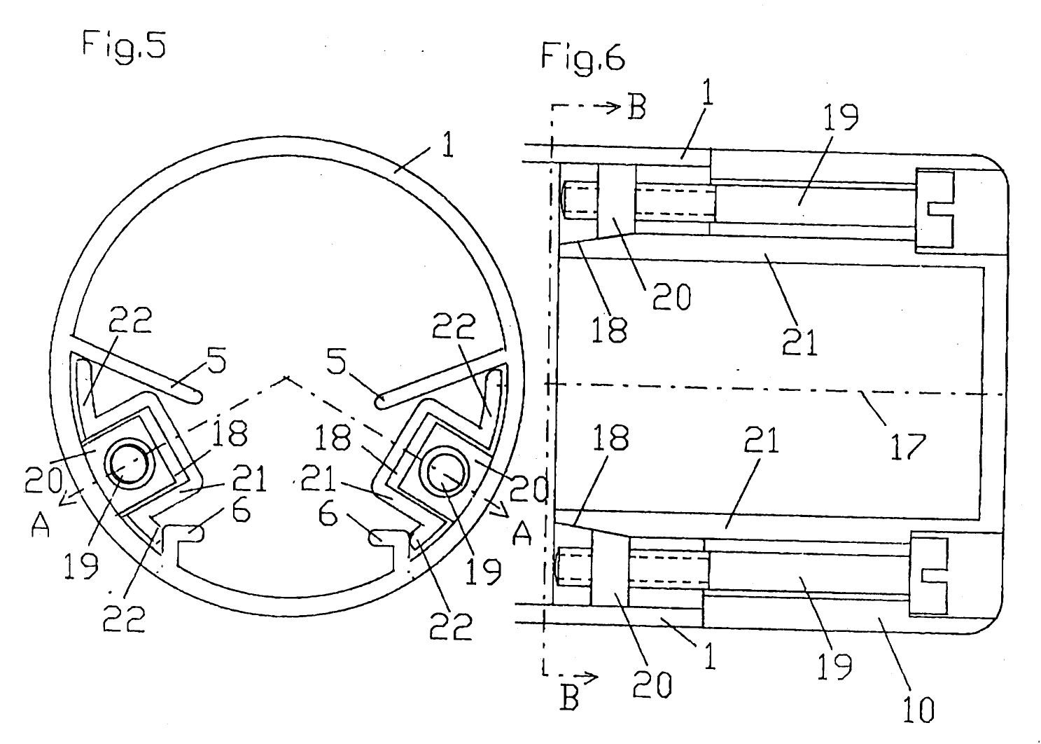

In order to ensure the secure positioning of the tube (1) with the adapter, FIG. 5 shows that stops (22) are provided on the guides (21) which support the printed circuit board (5) and the shoulders (6) for example. Since the guides (21) reach into the tube (1) as shown in FIG. 6, the end surface of the tube (1) requires no extra handling for this fastening procedure. The tube (1) can be mounted immediately as it comes off the extruder. It is irrelevant how far that the guides (21) reach into the tube and whether a more precisely centered addition to ensure the central positioning of the adapter is required.

Another version of the invention calls for a very transparent tube (1A) a second tube (1B) of white material which has light reflecting conducting surfaces (5) being pushed in. This calls for much simpler tools which can be manufactured cheaply and can also be made up of various combinations of pre-manufactured parts.

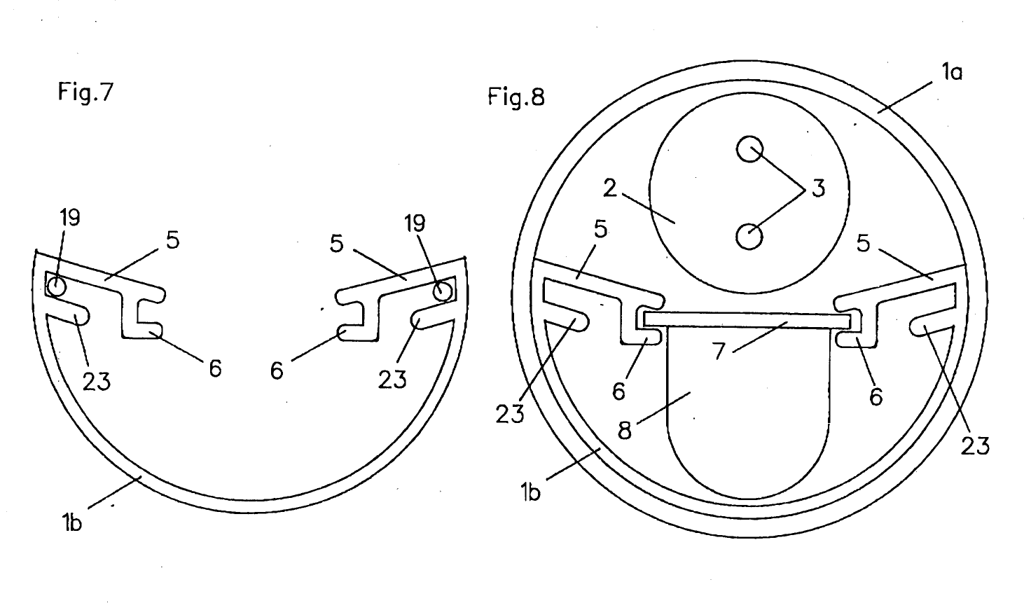

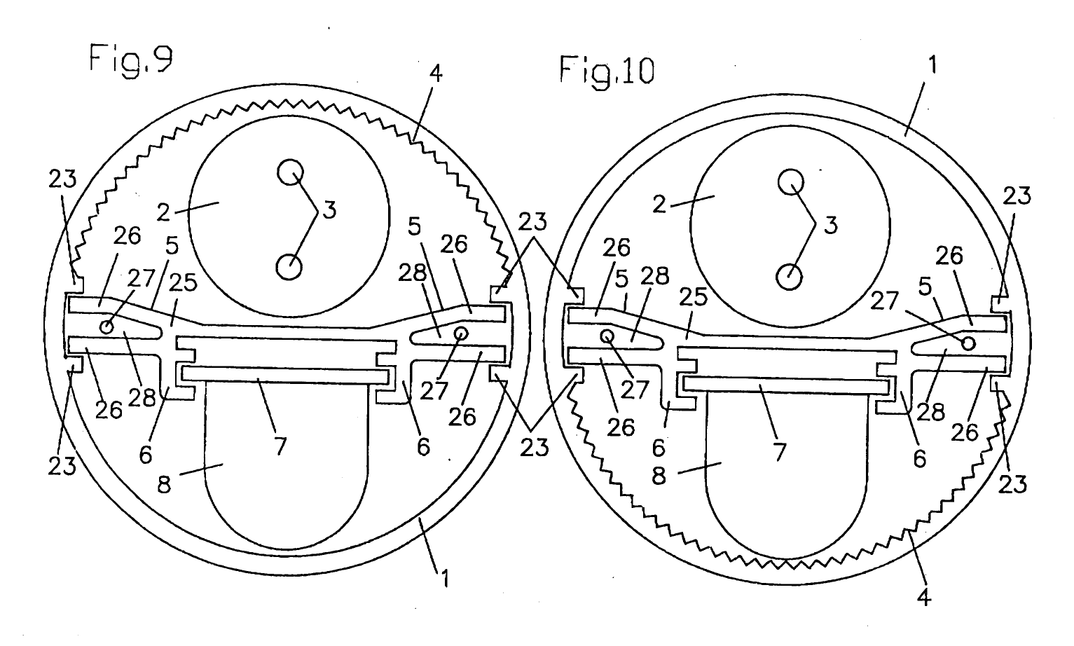

FIG. 7 shows a sample application of this type of inner tube (1B) with the reflecting conducting surfaces (5) and leads (6) for inserting a printed circuit board (7) with electronic components (8). The ribs (23) are located very close to the conductive surfaces (5) so that self-threading screws (19) can be screwed in between which connect the tube (1) with the terminating adapter (10) similar to FIG. 5 and FIG. 6.

FIG. 8 shows the assembly of the transparent tube (1A) with the white inner tube (1B) and the T5 fluorescent lamp (2) as well as the inserted printed circuit board (7) with electronic components (8). All remaining pieces are shown using the same indicator numbers as in the other figures.

Another advantageous version of the invention is instead of the second inner tube, a mainly flat inner profile (25) made of reflective material that can be slid into the tube (1) between the ribs (23). If the ribs (23) are symmetric then the inner profile (25) can also be slid in turned 180 degrees. This makes it possible to structure the two halves of the tube (1) differently, e.g., one half with a light-scattering profile (4) and the other half transparent glass clear. Matting one half for covering up the built-in electronics (8) and any other cover surface on the other half is advantageous. A version, e.g., with different rippled patterns on each half is also advantageous. These novelties provide the product with a major edge over standard solutions.

In order to reduce extra processing, the inner profile (25) can also be made several millimeters shorter than the outer tube (1). This creates sufficient space between the inner profile (25) and the adapter (10) to e.g. run connecting wires (27) from the electronic components (8) to the contact pins (3). The minimum distance can be ensured with supports (26) on the plastic parts of the adapter (10) e.g. in the form of raised eyelets around the screws (19).

Instead of the clamp connection with the clamp sockets (20) as shown in FIG. 5 and FIG. 6, an alternative is suggested by which the spacing for the forked hollow space is measured so that a self-threading screw (19) for connecting the adapter (10) with the inner profile (25) can be set in between. The screws (19) can be accessed through the front of the adapter and are safe from any parts carrying current.

The forked hollow space (28) also enables the inclusion of the required connection lines (27) between the adapters (10), whereby the connection lines (27) and any other connections, e.g., with the printed circuit board (7), are made so that they can be easily disconnected.

Previous descriptions were limited to “retrofit” lamps. It is, however, not necessary to continue with further details of connection sockets that are used in place of the contact pins (14) on the end of the adapter (10), which can exist in numerous variations. For this purpose, the clamp attachment with the screws (19) is especially suitable and provides a solution for fastening any form of adapter and outer end surface. All screw clamps or screwless clamps or other connection elements with or without cover or optional holders for hanging the lamps can be attached.

In summary, we have determined that the intended construction handles all tasks that can be given to such a lamp with a minimum amount of parts and with as few process steps as possible.

What is claimed is:

1. A light fixture for T5 fluorescent lamps or fluorescent lamps smaller than ⅝ of an inch in diameter, said light fixture comprising a cylindrical at least partially transparent tube fitted with adapters at both ends that contain electrical connectors adapted to mount T5 fluorescent light, where the adapter-containing tubes are fitted with electrical components necessary to operate the T5 fluorescent light, characterized in that an inner surface of the tube comprises a light-reflecting surface.

2. A light fixture in accordance with claim 1, characterized in that the inner surface is curved so that the light can be focused.

3. A light fixture in accordance with claim 1, characterized in that a semi-circular inner profile can be inserted into the transparent tube and that it has light-reflecting surfaces and shoulders for accepting the printed circuit board.

4. A light fixture in accordance with claim 1, characterized in that an inner profile can be inserted into the transparent tube, which has ribs, light-reflecting surfaces, and connectors to the circuit board.

5. A light fixture in accordance with claim 1, characterized in that a portion of said light-reflecting surface has connectors for an electronic relay, such as a printed circuit board with electronic components.

6. A light fixture in accordance with claim 1, characterized in that the light-emitting area of the tube is fitted with a light-dispersing groove profile (4).

7. A light fixture in accordance with claim 1, characterized in that in the area where no light is emitted, the tube is covered with an opaque tube coating.

8. A light fixture in accordance with claim 1, characterized in that the tube is made of two different materials, one transparent and one opaque.

9. A light fixture in accordance with claim 1, characterized in that the printed circuit board that contains the electronic components reaches at least one of the two adapters and all required contact joints to the fluorescent lights, for example, contact sockets and external connections, such as contact pins.

10. A light fixture in accordance with claim 1, characterized in that at least one of the two adapters is fitted along the longitudinal axis of the appropriate surface of the tube with a clamp socket that can be affixed to the interior portion of the tube with a screw.

11. A light fixture in accordance with claim 1, characterized in that the ribs are arranged so the tube is divided into two symmetrical halves, allowing the inner profile to be placed into position in two pieces at an angle of 180°.

12. A light fixture in accordance with claim 1, characterized in that the tube is made of two symmetric but different halves, such that the half is transparent and half is ribbed.

13. A light fixture in accordance with claim 1, characterized in that next to the adapters near where the eye-like openings are raised by the screws, a gap remains between the inner profile and the surface of the adapter.

14. A light fixture in accordance with claim 1, characterized in that the working ends of the inner profile are forked and form a gap into which a self-threading screw can be inserted.

15. A light fixture in accordance with claim 1, characterized in that connecting members between the adapters or printed circuit board are plugged into the hollow forked cavities of the inner profile.

16. A light fixture for mounting a small-diameter fluorescent lamp having a diameter less than or equal to five-eighth's of an inch into a fluorescent lamp holder, comprising:
a cylindrical tube having a diameter greater than five-eighth's of an inch, said tube having at least one transparent section extending longitudinally therein;
a light-reflecting member within said cylindrical tube, said member comprising a light reflecting surface and a pair of tracks for mounting a circuit board containing electrical components for supplying power to a small diameter fluorescent lamp; and
adapters at each end of said cylindrical tube, each of said adapters having a socket for receiving a pair of pins of a small diameter fluorescent lamp, and each of said adapters having a pair of outwardly extending pins for mounting the light fixture into a fluorescent lamp holder designed for lamps having a diameter greater than five-eighths of an inch.
